(19) United States
(12) Patent Application Publication
(10) Pub. No.: US 2007/0126542 A1
(43) Pub. Date: Jun. 7, 2007

(54) Transformer

(75) Inventors: Handy He, Taoyuan Hsien (TW); Johnson Li, Taoyuan Hsien (TW); Wd Li, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/398,590

(22) Filed: Apr. 6, 2006

(30) Foreign Application Priority Data
Dec. 2, 2005 (TW) 094220920

(51) Int. Cl. H01F 27/02

(52) U.S. Cl. 336/83

(57) ABSTRACT

A transformer applied to an electronic device includes a bobbin, an iron core assembly and an insulating case. The bobbin includes a winding region. The iron core assembly is disposed at both ends of the bobbin. The insulating case covers at least one portion of the iron core assembly and is located between the iron core assembly and the electronic device.

### BACKGROUND OF THE INVENTION

1. Field of Invention

The present invention relates to a transformer, and more particularly to a transformer conforming to safety specification.

2. Related Art

Transformer is a frequently used electronic assembly in a variety of electric apparatuses. As shown in FIG. 1, a conventional transformer 1 includes a bobbin 11, a winding 12, a terminal seat 14 and iron cores 15. The winding 12 generally winds a winding region 111 of the bobbin 11 by at least one enamel-insulated wire. The terminal seat 14 is connected with the bobbin 11, and has a plurality of terminals 141 to electrically connect with a circuit board 17. The iron cores 15 are disposed at both ends of the bobbin 11, and are electromagnetic coupled with the winding 12. As shown in FIG. 1, the axis of the bobbin 11 is parallel to the terminals 141 of the terminal seat 14 so as to be a vertical transformer. In addition, the transformer will be a horizontal transformer if the axis of the bobbin 11 is perpendicular to the terminals 141 of the terminal seat 14 (not shown).

Transformer must conform to a qualified safety specification since it involves the transformation of power. The distances between the iron cores 15 and the circuit board 17, and that between the iron cores 15 and the winding 12 should be maintained under the limit of the safety specification. However, the prior art devices can not conform to technical development under the trend of miniaturization of electronic assembly by heightening the vertical transformer to achieve safety distance.

It is thus imperative to provide a transformer conforming to safety specification and being compact.

### SUMMARY OF THE INVENTION

In view of the foregoing, the present invention provides a transformer conforming to safety specification and being compact.

To achieve the above, a transformer according to the present invention is applied to an electronic device. The transformer includes a bobbin, an iron core assembly and an insulating case. The bobbin includes a winding region. The iron core assembly is disposed at both ends of the bobbin. The insulating case covers at least one portion of the iron core assembly and is located between the iron core assembly and the electronic device. The winding region is generally wound by at least one enamel-insulated coil stacking up to form a winding. The winding is composed of a primary winding and a secondary winding.

To achieve the above, another transformer according to the present invention includes a bobbin, an iron core assembly and an insulating case. The iron core assembly has a first iron core and a second iron core. The first iron core and the second iron core are disposed at both ends of the bobbin. The insulating case covers at least one portion of the first iron core and/or the second iron core, and the shape of the insulating case is corresponding to that of the first iron core and/or the second iron core. The insulating case is made of insulator, such as plastic.

As mentioned above, a transformer according to the present invention utilizes an insulating case covering at least one portion of the iron core assembly and being located between the iron core assembly and the electronic device, especially being located between the iron core assembly and a circuit board of the electronic device. By utilizing the insulating effect of the insulating case, the present invention needs not to heighten the transformer for conforming to the safety distance between the iron core assembly and the circuit board when the transformer is installed on the circuit board. Comparing with the prior art, the height of the product is thus lower and the product is more compact. The present invention can still conform to safety specification of the electric element under the trend of miniaturization of electronic assembly.

### BRIEF DESCRIPTION OF THE DRAWINGS

The present invention will become more fully understood from the detailed description given herein below illustration only, and thus are not limitative of the present invention, and wherein:

FIG. 1 is a schematic diagram showing a conventional transformer;

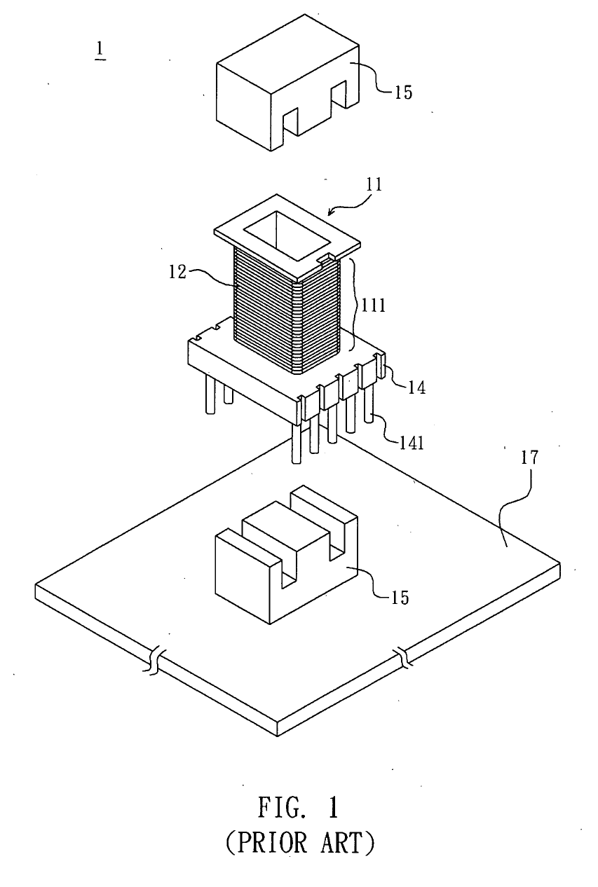

FIG. 2 is an exploded diagram showing a transformer according to the present invention; and

FIG. 3 is a combined diagram showing the transformer according to the present invention.

### DETAILED DESCRIPTION OF THE INVENTION

The present invention will be apparent from the following detailed description, which proceeds with reference to the accompanying drawings, wherein the same references relate to the same elements.

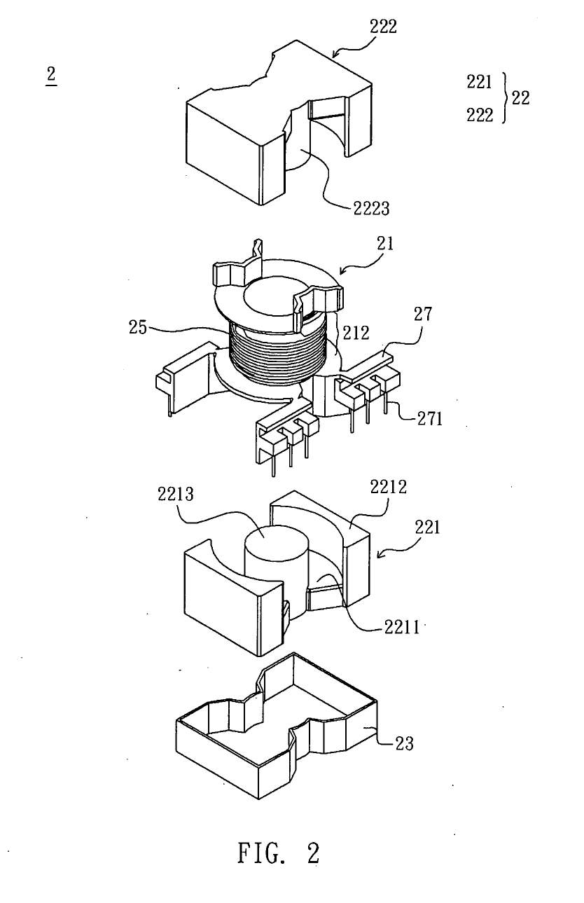

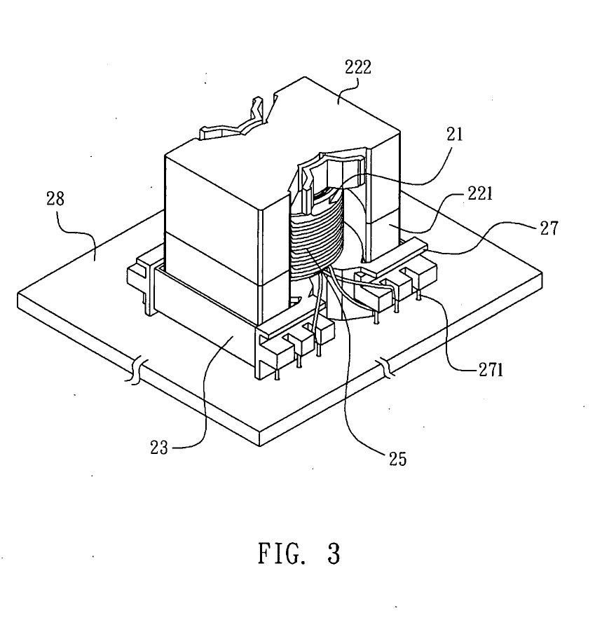

As shown in FIGS. 2 and 3, a transformer 2 according to the preferred embodiment of the present invention includes a bobbin 21, an iron core assembly 22 and an insulating case 23. The transformer 2 is applied to an electronic device. In this embodiment, the transformer 2 is a high-frequency vertical transformer.

The bobbin 21 further includes a winding region 212. The winding region 212 is generally wound by at least one enamel-insulated coil stacking up to form a winding 25. The winding 25 is composed of a primary winding and a secondary winding.

The iron core assembly 22 is disposed at both ends of the bobbin 21. In this embodiment, the iron core assembly 22 has a first iron core 221 and a second iron core 222. The first iron core 221 and the second iron core 222 are respectively disposed at opposite ends of the bobbin 21 and are electromagnetic coupled with the winding 25 to achieve the purpose, of voltage transformation. In this embodiment, the iron core assembly 22 is in PQ core. Of course, the iron core assembly 22 may also be constructed by EE cores, EI cores, RM cores, E cores, EC cores or ETD cores.

The first iron core 221, for example, has a horizontal portion 2211, a plurality of side portions 2212 and a protruding portion 2213. The side portions 2212 are respectively connected with the side edges of the horizontal portion 2211. The protruding portion 2213 is cylindrical and is vertically disposed on the central region of the horizontal portion 2211. The protruding portions 2213 and 2223 of the iron cores 221 and 222 are coupled with the bobbin 21, respectively.

In this embodiment, the transformer 2 further includes a terminal seat 27 connected with the bobbin 21. As shown in FIG. 3, the terminal seat 27 includes a plurality of terminals 271 electrically connected to a circuit board 28 of the electronic device. In this embodiment, the terminal seat 27 and the bobbin 21 may be integrally formed.

The insulating case 23 covers at least one portion of the iron core assembly 22. The insulating case 23 may be designed in accordance with the shape of the iron core assembly 22 to cover at least one portion of the iron core assembly 22. The shape of the insulating case 23 is corresponding to that of the iron core assembly 22. The insulating case 23 is made of insulator, such as plastic. In this embodiment, the insulating case 23 covers the horizontal portion 2211 of the first iron core 221, and is located between the iron core assembly 22 and the circuit board 28 as shown in FIG. 3.

In summary, a transformer according to the present invention utilizes an insulating case covering at least one portion of the iron core assembly and being located between the iron core assembly and the electronic device, especially being located between the iron core assembly and a circuit board of the electronic device. By utilizing the insulating effect of the insulating case, the present invention needs not to heighten the transformer for conforming to safety distance between the iron core assembly and the circuit board when the transformer is installed on the circuit board. Comparing with the prior art, the height of the product is thus lower and the product is more compact. The present invention can still conform to safety specification of the electric element under the trend of miniaturization of electronic assembly.

Although the present invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the present invention.

What is claimed is:

1. A transformer, comprising:
a bobbin;
an iron core assembly having a first iron core and a second iron core, and coupled with both ends of the bobbin; and
an insulating case covering at least one portion of the first iron core and/or the second iron core.

2. The transformer according to claim 1, wherein the bobbin comprises a winding region wound by a coil.

3. The transformer according to claim 1, wherein the iron core assembly is constructed by EE cores, EI cores, RM cores, E cores, PQ cores, EC cores or ETD cores.

4. The transformer according to claim 1 further comprises a terminal seat connected with the bobbin.

5. The transformer according to claim 4, wherein the terminal seat comprises a plurality of terminals electrically connected with a circuit board.

6. The transformer according to claim 5, wherein the insulating case is located between the circuit board and the first iron core and/or the second iron core.

7. The transformer according to claim 1, wherein the shape of the insulating case corresponds to that of the iron core assembly.

8. The transformer according to claim 1, wherein the insulating case is made of insulator.

9. The transformer according to claim 8, wherein the insulator is plastic.

10. The transformer according to claim 1 is a vertical transformer or a high-frequency transformer.

11. A transformer, applied to an electronic device, comprising:
a bobbin;
an iron core assembly disposed at both ends of the bobbin; and
an insulating case covering at least one portion of the iron core assembly, and being located between the iron core assembly and the electronic device.

12. The transformer according to claim 11, wherein the bobbin comprises a winding region wound by a coil.

13. The transformer according to claim 11, wherein the iron core assembly is constructed by EE cores, EI cores, RM cores, E cores, PQ cores, EC cores or ETD cores.

14. The transformer according to claim 11 further comprises a terminal seat connected with the bobbin.

15. The transformer according to claim 14, wherein the terminal seat comprises a plurality of terminals electrically connected with a circuit board.

16. The transformer according to claim 15, wherein the insulating case is located between the iron core assembly and the circuit board.

17. The transformer according to claim 11, wherein the shape of the insulating case corresponds to that of the iron core assembly.

18. The transformer according to claim 11, wherein the insulating case is made of insulator.

19. The transformer according to claim 18, wherein the insulator is plastic.

20. The transformer according to claim 11 is a vertical transformer or a high-frequency transformer.
